(19) United States
(12) Patent Application Publication
(10) Pub. No.: US 2012/0041847 A1
(43) Pub. Date: Feb. 16, 2012

(54) Wine List Management and Display on Tablet and Mobile Devices using a World Wine Database

(75) Inventors: Goncalo Jose Cardoso Nunes Caeiro, Linda-a-Velha (PT); Rui Jorge da Silva Vala, Lisbon (PT)

(73) Assignees: Rui Jorge da Silva Vala, Lisbon (PT); Goncalo Jose Cardoso Nunes Caeiro, Linda-a-Velha (PT)

(21) Appl. No.: 12/856,473

(22) Filed: Aug. 13, 2010

(51) Int. Cl. G06Q 30/00

(52) U.S. Cl. 705/27.1

(57) ABSTRACT

The present invention claims a method for managing, building and presenting wine lists to people in restaurants, hotels, wineries and homes through tablet or mobile phones. The information about the wines is saved in a central server accessed via internet with information directly by the wine producers and wineries. The user that manages the wine list configures the wine list through the web portal and then synchronizes the wine list configuration with a tablet or mobile device and saves that information locally in the device. The tablet or mobile device can present the wine list while being disconnected from the internet.

### DEFINITIONS

Tablet device—presented definition used in this document refers to a group of computing devices comprising slate or tablet shaped mobile computer device, equipped with a touch screen or stylus.

### BACKGROUND OF THE INVENTION

The present invention claims a method for managing, building and presenting wine lists to people in restaurants, hotels, wineries and homes through tablet or mobile devices which are configured by a portal that has a wine database updated directly from the wine producers and wineries.

The wine lists are in the vast majority of restaurants, hotels and others places supplied in paper format. Paper is still by far the most popular media for allowing the consumer to choose the wine he/she wants to have at restaurants.

Paper based wine lists pose a hard challenge for restaurants. Whenever a wine is out of stock, a new wine enters the market or the wine price changes, the restaurant face a dilemma of what do to: either spend a lot of money in rebuilding the wine list, or refuse to incorporate the changes.

The common approach in restaurants in to build a wine list every year, keeping frozen any changes during that period. Even so, the challenge of wines out of stock remains. A difficult situation for a restaurant (and the restaurant waiter) occurs every single time a customer asks for a wine that is in the list but that it is out of stock in the restaurant. If by chance the customer chooses three wines that are not available in a good restaurant, the customer usually will quit trying choosing carefully the wine and asks the waiter which wines are available.

The solution is to update on a regular base the wine list, but that poses economic challenges. It is not uncommon in high rate restaurants to find wine lists that are almost pieces of art. The wine lists at these places are custom made lists, made by hand. Those wine lists must be considered prototypes and is common that building a wine list costs some tens of thousands dollars.

Two recent trends show alternative ways to create food and wine lists.

The first alternative way is providing software to create or edit a configuration that allows a restaurant to build their own wine list from scratch. To do so the wine list manager at the restaurant must input all information about every wine into that application. This type of system is nothing more than an advanced document editor that enables restaurants to manage more easily their wine lists. However these types of systems have several main problems that are not solved. First it delegates the entire responsibility of inputting the information of wines meaning that many restaurants and doing the same work. The second problem is that the restaurant doesn't have online information about the new wines that are coming into the market, since the wine database is local to the restaurant. The problem is that the information may not be reliable since the wine information source is already filtered by the restaurant wine list manager. The fourth problem is that only a very summarize information is available to the restaurant and usually is the information contained in the wine bottle label.

The second alternative way is to use a device that is connected to the internet, either a table device or a computer to show in a web browser a wine list that is configured in the portal. Although we are moving towards a truly always online world, we are not still there. This alternative doesn't work in any restaurant or situation with no internet access or poor internet access. This second alternative is a variation of the first alternative since the systems require the restaurant to create their own wines database and only after to create their wine lists based upon their own wine database.

That is the reason why the adoption of tablet systems in restaurants has been slow. On one hand the hardware itself was cumbersome and expensive and didn't provide a good user experience. On the other hand the requirements and efforts required in operating the device, either the internet access or the time to manage and build the wine list, have put off restaurants to adopt such technology.

There are several hundred thousands of wine producers in the world, possibly more than a million. There is no actual consolidated world statistics on this since many wine producers are very small, local and with small wine productions.

The wines are a peculiar product since every year there is another crop. Although a wine can have the same name, the actual product is different from year to year. And the wines can be saved in cellars during decades.

Thus a method for building, managing and presenting wine lists is presented by the invention depicted in this document.

### CURRENT STATE OF THE ART

The field of using technology in restaurants is still quite new. Next we present some filled patents that although introduced the use of technology by consumers in restaurants don't have a direct relation or overlap to the herein proposed invention.

The current state of the art focus mainly on paper apparatus or the process of ordering items using solely devices and systems and solutions that are not connected to a centralized world database. The focus of past inventions has been for improving the productivity of the order process rather than improving the way the customer chooses the wines and the way the restaurant managers can build their wine lists.

U.S. Pat. No. 7,454,370—Electronic menu apparatus and method of ordering using electronic menu apparatus

U.S. Pat. No. 7,010,267—Arrangement with beacon for providing information service

U.S. Pat. No. 6,865,261—Method for providing gastronomic information and instruction with an internet server using mobile communications or computing devices and intelligent appliances

U.S. Pat. No. 6,859,215—Method, system and program for specifying an electronic food menu on a data processing system

U.S. Pat. No. 6,646,659—Method, system and program for specifying an electronic food menu with food preferences from a universally accessible database

U.S. Pat. No. 7,418,413—“System and method for synchronizing restaurant menu display with progress through a meal”.

The current hundreds of initiatives of providing wine portals rely on information that is not updated directly by producers and wineries but from users via a social networking and web 2.0 paradigms. This approach however results in wine databases that are not validated and that don't have enough information quality to supply information for building restaurants wine lists.

### BRIEF DESCRIPTION OF THE DRAWINGS

FIG. 1 is a diagram illustrating the overall architecture and users roles involved in the process.

FIG. 2 is a diagram of the flux if the life cycle of a wine list.

FIG. 3 is a diagram of the main modules of web portal.

### DESCRIPTION OF THE INVENTION

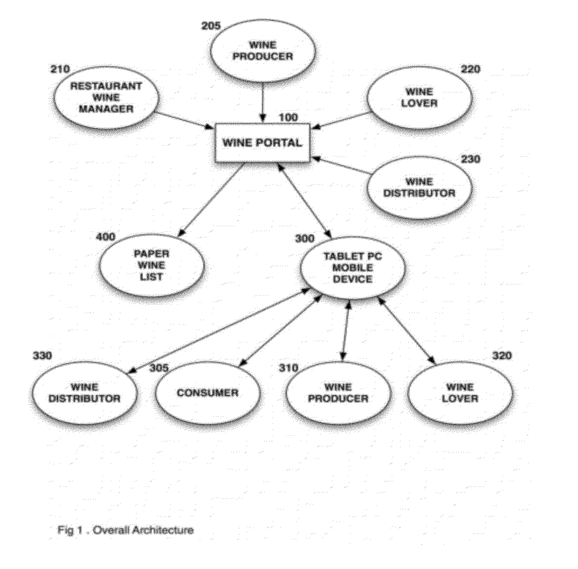

This invention describes in FIG. 1 a wine web portal 100 that contains a world wine database that is reliable and thus can serve as a reference for restaurants, distributors or consumers to use it. The web portal wine database is updated directly by wine producers and wineries 205. The wine producers and wineries are the only entities that have the all technical information of the wine and thus are the only ones we should trust to create edit and update wine information.

The wine web portal 100 has a database of wines from all over the world. The wines are classified by country, type, sub type, region, sub region, variety, alcohol percentage, and other wine characteristics.

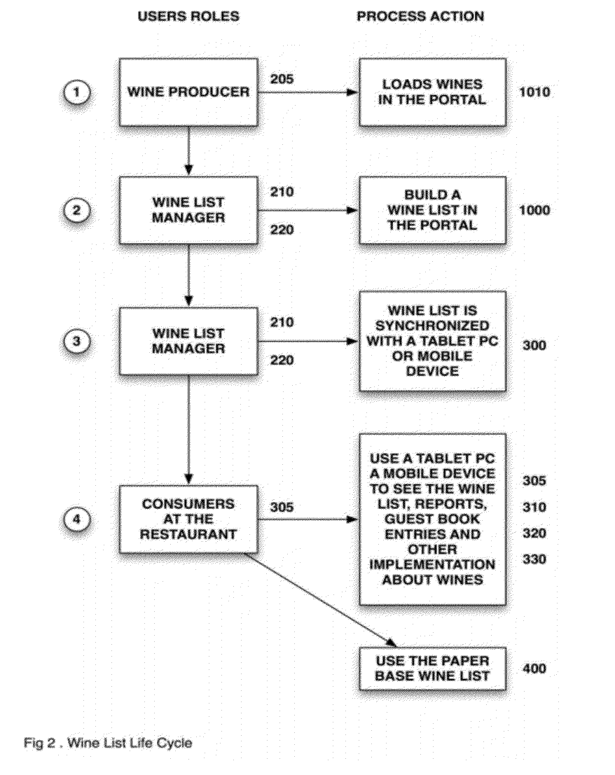

In FIG. 1 and FIG. 2, the restaurants wine managers 210, the wine lovers 220 and the wine distributors 230 can create wine lists 1000 based on wines 1010 that are loaded in the wine web portal 100. All the three types of users 210, 220 and 230 can create their own list of custom wines 1020 that are not shared among the other users of portal. This enables all types of users to create swiftly their wine lists 1000 and only add the wines that are yet in the database. To create a wine list the users can select the wines 1010/1020 either by the portal user interface or by uploading a file that contain wine name and year, EAN code or the web portal wine code. This process enables a very fast wine list configuration since 90% of the world wine bottles have EAN (barcode) codes. Because the web portal has information about the wines and the different packages introduced by the wine producer, it is possible to identify the wines based in the EAN codes.

The users can create as many lists as they want. They can publish the wine list 1000 to a table computer device or mobile device 300 by sending a wine list structured in structured file like XML. This publishing will send the information across the internet based after a successful login so that the portal 100 can identify who is synchronizing. The synchronization process identifies which list is to be synchronized with that device 300. A restaurant can have several wine lists 1000 published to several devices 300 at the same time.

In FIG. 2, the portal users can configure the wine list via a web user interface 1200. Or the users can download a wine list configuration file 1100 having information about the wine web portal code, wine name, measure, year, producer and prices and other wine information in a CSV, XML or other structured format. The user can update the information about prices and stock quantities and upload again the file 1100. The web portal 100 will reconsolidate the information. When the tablet or mobile devices 300 connect to synchronize the information, the recently changed information in the web portal is exported to those devices. The management of work for the restaurants is greatly simplified.

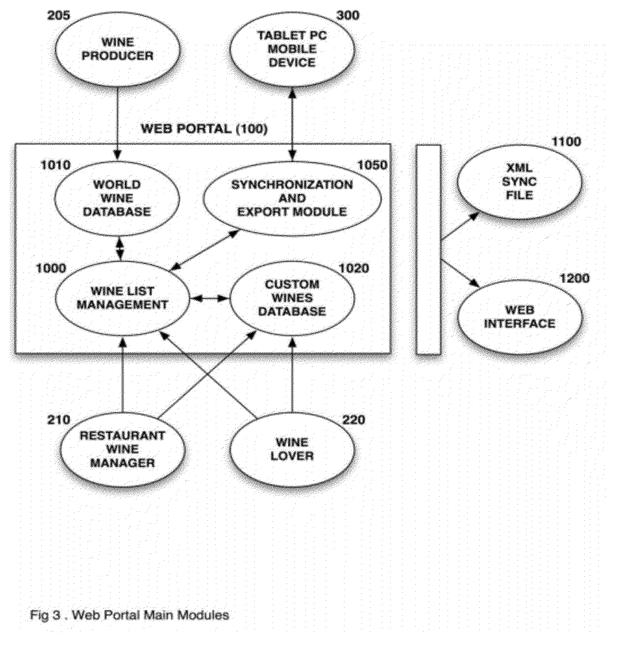

In FIG. 3, the consumer 305 choosing wines at the restaurant browses the wine list 1000 in the tablet or mobile device 300 in a powerful away. The consumer 305 can list wines by country, variety, producer, region, price or ratings, with a much more powerful interface than a paper base wine list 400 allow. The user by interacting with the application in the tablet or mobile device 300 can create and save information that is again feed backed to the web portal 100. Examples of such information are the consumer guest books entries or the request for getting more information about the wines. This bidirectional interaction in innovative and it is not possible using the common paper based wine lists.

The devices 300 during the synchronization send the statistics about the wines that were viewed by the consumers at the restaurant.

However, restaurants that don't have tablet or mobile devices 300 can use the wine web portal 100 to create ready printable documents like PDFs wine lists 400. This document wine lists 400 can be printed in a common fashion and enable restaurants to present paper based wine lists to consumers.

A major difference between these paper based wine lists 400 is that the content comes from information stored in the central wine web portal 100 and it is not solely introduced by the users 210, 220 or 230.

Because the devices 300 store the information locally the devices do not need to be connected to the internet enabling the use of the devices 300 in an offline mode. This feature is crucial to ensure added security and to allow consumers to use with a high quality experience without being impacted by internet service failures either local or due to the internet service provider.

It also allows other types of users, like the wine distributor salesman 230 to show their wines to prospect restaurants without the need for having a live connection to the Internet. This is especially important in remote areas, enabling salesman to demo show their portfolio with a high quality and user's interactive application instead of just a fixed and static electronic document or paper catalog

Because the wine database is the same for all restaurants the system can provide statistics across the wine ecosystem. It is possible for the wine producers 205 to know which restaurants that have their wines.

The proposed invention takes a leap forward by merging the concepts of a global wine database 1000, with local synchronization to devices 300 at specific times and offline usage of those same devices, allowing a collaborative environment between all participants in the wine value chain industry.

What is claimed is:

1. A method of creating, managing and displaying wine lists to consumers using a web portal containing a world database of wines that is updated directly by wine producers and wineries.

2. A method according to claim 1 of a consumer to browse the wine list in a tablet or mobile device to find detailed information about the wines, their characteristics, producer information, related wines, prices and availability at restaurants and similar establishments.

3. A method according to claim 1 of building wine list paper based by using the central web portal to configure the wine lists using the centralized database of wines and allowing the user to create a ready printable formatted document that contains the wine list based on a templates and skins available at the portal.

4. A method according to claim 1 of classifying wines in a standard way for all over the world based on a group of standard categories and the wines are coded so that a wine, independently of the package or measure, is uniquely identified. Thus the same wine, even if bottle in bottles with different sizes, has a single wine code, instead of a different code by each package/measure type.

5. A method according to claim 1 of facilitating wineries, restaurants, wine distributors and wine lovers to build a catalog of their wine stock.

6. A method according to claim 5 of configuring wine list in the portal by importing the EAN code present in the bottles and match that EAN (barcodes) code and other codes that can distinguish wine bottles against the portal world wine database to automatically selecting the wines that belong to the restaurant wine list.

7. A method according to claim 1 of synchronizing the wine list configuration resident in the web portal with a tablet or mobile device in a way that the wine list is stored locally in the device to allow users to use the wine list browse application even if the tablet or mobile device are disconnected from the Internet.

8. A method according to claim 7 of a consumer that is using the table or mobile device containing the wine list to request additional information from a wine producer of a specific wine.

9. A method according to claim 7 of a restaurant to gain access to statistics about their consumers wine preferences.
